(19) United States
(12) Patent Application Publication
(10) Pub. No.: US 2018/0330427 A1
(43) Pub. Date: Nov. 15, 2018

(54) AUTOMATED PRICE RULE NOTIFICATION FOR ONLINE CONSUMERS

(71) Applicant: INTERNATIONAL BUSINESS MACHINES CORPORATION, ARMONK, NY (US)

(72) Inventor: Mohamed Jawahar Hussain, Bangalore (IN)

(21) Appl. No.: 15/592,347

(22) Filed: May 11, 2017

(51) Int. Cl. G06Q 30/06; G06Q 20/40; G06Q 20/12

(52) U.S. Cl. CPC G06Q 30/0635; G06Q 20/12; G06Q 20/405; G06Q 30/0643

(57) ABSTRACT

A real-time price rule notification method and system is provided for disparate products in a retailer-operated website. Retailer-definable selling criteria for merchandise is recorded at a data storage facility in real time from a plurality of disparate data sources. A customer interface is provided on a website enabling a customer to buy the merchandise at an offered price point. The customer is able to tag merchandise thereby defining a customer-defined product set of merchandise, and provide customer-defined buying criteria. The buying criteria include rule-governed pricing input by the customer for a group of disparate products included in the product set. The buying criteria are recorded at the data storage facility. The system executes real time, periodically computational comparisons of the selling and buying criteria. The system sends a notice, in real time, a notice to the customer in response to the retailer-definable selling criteria matching the customer-defined buying criteria.

### FIELD

The prevent invention is directed, in general, to electronic systems for buying and selling merchandise, and in particular, to an ecommerce system using a price rule engine to automatically trigger electronic retail transactions.

### BACKGROUND

The buying and selling of merchandise through electronic systems—i.e., “e-commerce”—is currently well accepted and pervasive.

With numerous retailers and other commercial entities participating in e-commerce activities, price competition has intensified. Flatter pricing models are particularly prevalent in the online retail sales sector, wherein the internet has substantially reduced customer costs for acquiring product information and for purchasing merchandise. Online competitors are numerous and customers are knowledgeable.

One online method currently used to engage retail customers is to offer online subscriptions to electronic alerts and news, thereby promoting customer awareness, attention, and interest in the retailer and/or the retailer's merchandise. In one variation, the customer is electronically alerted whenever a retailer announces a sale, promotion, new product offering, or new product pricing. The subscriber is typically provided with means to select the type of alert received. For example, most (if not all) online retailers allow subscribers to opt out of generic promotional alerts and receive only those alerts related to a particular product or service. While current customer alert and notification systems continue to provide retail utility, there is growing interest in providing even more advanced systems. Increasing customer awareness leads to increasing sales. By providing customers with means to improve the customer awareness and understanding of retail offerings, the customers are more likely to pursue the retail offerings.

It has been observed however that when information is generic and of little relevance to a customer, the value of communicating that information will diminish progressively over time. With customer attention lowered in response to a stream of generic information, the occasional transmission of information that is specific and relevant, and that may lead to a sale, can easily be overlooked.

To prevent such missed opportunities, an automated alert system that is specific and relevant—as well as flexible and comparatively easy to implement within an e-commerce framework—is needed.

### SUMMARY

The present invention provides a system and method for real-time automated price rule notification for disparate products selected from a group of products in at least one retailer-operated e-commerce website. The at least one e-commerce website is coded to sell merchandise according to retailer-definable selling criteria, where the selling criteria comprise at least an offered price point. A computer records retailer-definable selling criteria for merchandise at a data storage facility in real time from a plurality of disparate data sources. The computer provides a customer interface on a website enabling a customer to buy said merchandise at an offered price point. The computer receives, by the customer interface on the computer, a selection to tag merchandise which defines a customer-defined product set of merchandise of interest to the customer. The computer receives customer-defined buying criteria, where the buying criteria comprises rule-governed pricing input by the customer for disparate products included in the customer-defined product set. The computer records the customer-defined buying criteria at the data storage facility and executes, real time, periodically computational comparisons of the retailer-definable selling criteria and the customer-defined buying criteria. The computer sends, in real time, a notice to the customer in response to the retailer-definable selling criteria matching the customer-defined buying criteria.

For a further understanding of the nature and objects of the invention, reference should be had to the following description taken in conjunction with the accompanying drawings.

### BRIEF DESCRIPTION OF THE DRAWINGS

FIG. 1 illustrates schematically certain components of a computer network arranged to host an ecommerce website structured in accordance with an embodiment of the present invention.

FIG. 2 illustrates a representative customer interface for a hypothetical ecommerce website according to an embodiment of the present invention.

FIG. 3 illustrates a hypothetical webpage or dashboard showing products selected by a consumer in accordance with an embodiment of the present invention.

FIG. 4 illustrates an example of a product set selected by a consumer to define a shopping list of items according to an embodiment of the present invention.

FIG. 5 illustrates an example of a ruling engine page providing pricing options and rules for use by the consumer according to the present invention.

FIG. 6 illustrates an exemplary customer interface showing the selective pricing rule being applied to product set A of FIG. 4 in accordance with an embodiment of the present invention.

FIG. 7 illustrates a notice interface presenting products matching the customer's conditions set forth in the ruling engine according to an embodiment of the present invention.

FIG. 8 provides an illustration of a representative “alert” triggered by a personal price point, such as that illustrated in FIG. 2, according an embodiment of the present invention.

FIG. 9 is a flowchart showing the steps of applying price rules to a group of products identified by a customer according to an embodiment of the present invention.

FIG. 10 illustrates a flowchart showing an example of consumer data flow according to an embodiment of the present invention.

FIG. 11 illustrates a flowchart for one example of system data flow according to an embodiment of the present invention.

FIG. 12 illustrates a computer system used for implementing the methods of the present invention.

### DETAILED DESCRIPTION

E-commerce saw a rapid growth over the last several decades. This growth facilitated consumers to review large variety of products online across multiple vendors and able to make a smart choice with their purchase orders. One of the key features that would facilitate consumers placing order is the provision for financial planning with the online retailers which ensures that the customers will only place an order when certain pricing conditions of the intended purchase items are fulfilled. This in return helps the consumers prioritize their requirements, ensure their requirements fall within their finance, and make wise decisions.

The present invention facilitates online consumers to set combination and relative pricing rule(s) based on the consumer's requirement against products or items so that the online retail system will notify the consumers in real time when a rule or set of rules is fulfilled. The implementation of the pricing rules will help consumers plan their purchase based on their budget and ensure the consumers buy a single or combination on products within a stipulated time period only when the pricing is within the customer's desired limit. The system and method of the invention monitors, in real time, the pricing data of disparate products accumulated from a single website or from multiple sources to enable the customer monitor pricing data of multiple products which may be bundled together as a package according to pricing rules that will be further defined below.

The retail system will also provide the option of whether the purchase is an instant purchase or if the user should buy within a stipulated time period.

With reference to the accompanying drawings, the present invention is directed to an electronic retailer-operated system wherein the input of a “ruling engine”, alone or in combination with other customer buying criteria, provides a foundation for processes that result, directly or indirectly, in the execution of an automated real-time retail transactions, such as an electronic alerts and/or an electronic purchases.

The current system has provision to notify consumers on the pricing when a group of disparate products or a product set matches or satisfies criteria established by a ruling engine in real time as will be described in more detail below. The term “disparate” is intended to mean products from different product categories or originating from different sources as opposed to products from the same source or retailer. Thus, the system monitors products from different sources and compares process from these different sources such that a consumer may monitor, in real time, the prices of disparate products, which cannot be accomplished by current system or by human means alone. The proposed system provides flexibility to consumers to select a range of products and set the pricing rule based on the consumer's needs, and the system monitors and accumulates data from different sources related to different products that form a group of products defined by the customer or consumer.

This pricing rule or ruling engine can be based on combination of products and the ruling engine may be comparative or as well relative. The flexibility and real time features of the present invention assist online consumers purchasing a set of related on unrelated items. For example, assume a customer who wishes to purchase a video game console set. The consumer's choice of selection may, for example, include the base game console, additional joysticks, memory card, gun and a collection of games. The gaming products may originate from a single source or from multiple sources. The buyer can set rules such that the buyer will be notified only when the price of certain components or all of the components match a specified set of price criteria established by the consumer.

If a match or other suitable computed relationship is found, a real-time, automated electronic notification is sent to a customer's email address or smartphone number or other suitable notification system.

Other automated retail transactions, aside from electronic notifications, are supported. In certain embodiments, an automated electronic purchase of customer-selected merchandise is also a function of the computational comparison of buying and selling criteria. In particular, a customer electronically pre-authorizes the purchase of a selected item of merchandise (e.g., contemporaneously with the input of a personal price point), and provides customer purchasing information (i.e., contemporaneously or in a prior transaction). Upon suitable correlation of customer and retailer criteria, the item is automatically purchased using the customer's purchasing information.

In accordance with the invention, there are a variety of pricing rules utilized by the pricing engine that may be selectively applied by the consumer. For example, there may be cumulative pricing, conditional pricing, selective pricing and combined pricing rule. The following scenarios explain a real time applicability of this invention. By way of example, a store has n number of products namely x1, x2, x3, . . . , xn. A consumer wishes to purchase x1, x2, x3, x4 and x5. The possible set of rules that be applied to ensure the rule is met before the order is placed is as follows:

1. Cumulative Pricing Rule

When the price of all the items are added together, the price should be less than or equal to z.

x1+x2+x3+x4+x5<=z

2. Conditional Pricing Rule

When one or more product falls below certain price range the purchase condition is true

if(x1<=z1) or if(x2<=z2) or if(xn<=zm)

3. Selective Pricing Rule

When each product in the condition falls below the stated price range.

if(x3<=z1) and if(x4<=z2)

4. Combined Pricing Rule

Rule consisting of two or more of the above mentioned ruling system

if(x1<=z1) and/or (x1+x2+x3+x4+x5<=z)

All the above pricing conditions can be applied by a consumer. Consumers can benefit by buying products only when specific criteria are met, and the consumer is notified in real time of the pricing condition of disparate products that otherwise would not be sufficiently monitored by systems currently known in the art.

In certain embodiments, the invention is structured as an online retail website with a shopping list facility that enables a customer, using the customer interface, to record in association with a customer account a list of merchandise desired for future purchase and/or further consideration. Merchandise within (or to be included in) this shopping list is tagged with customer-defined buying criteria, thereby prompting an automated electronic alert and/or electronic purchase when met.

In another embodiment, the invention is structured as an Internet application installable, for example, on a customer smartphone. The internet application comprises a customer interface (functionally similar to that employed for an e-commerce website) and means for engaging, interacting, and communicating with the retailer's e-commerce facility to effect periodic computational comparisons of buying and selling criteria and triggering electronic alerts and/or purchases.

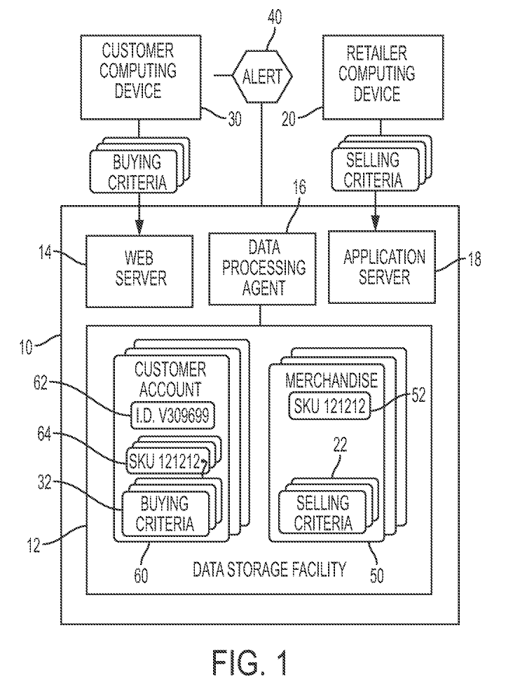

FIG. 1 illustrates schematically certain components of a computer network arranged to host an ecommerce website structured in accordance with an embodiment of the present invention. As shown, computer network 10 comprises a data storage facility 12, a data processing agent 16, a web server 14, and an application server 18. Data storage facility 12 is used to store data relating to customer accounts 60, merchandise 50, and any buying and selling criteria associated therewith. Data processing agent 16 is used for computational comparisons. Application server 18 is used by the retailer for inputting selling criteria. Web server 14 is used for publishing (to customers) an ecommerce website that incorporates the personal price point features of the invention.

The e-commerce website, published through web server 14, is accessed at a Universal Resource Locator (URL) address, using an internet browser or other suitable web interface, through a customer computing device 30, such as a smart phone, tablet, or personal computer. The website provides a means for a retailer to sell merchandise to customers, wherein buying and selling is consummated electronically through a “virtual storefront”. Transactions initiated on this virtual storefront are executed through resources within the retailer's computing network 10, and fulfilled through “back office” integration, shipping, and fulfillment facilities, also operated, managed, and/or directed by the retailer.

Programming for the e-commerce website includes HyperText Makup Language (HTML), alone or in combination with other internet programming and scripting languages, providing feature-rich functionality, such as dynamic data interchange, presentation, and management; cross browser/device compatibility, and appropriate online safeguards and security. Other programming and scripting languages include PHP, JavaScript, JQuery, XML, Ajax, and Java. CSS can be used, for example, to provide good cross browser/device compatibility.

The computing resources for the website need not be contained in one central logical or physical location. As known to those skilled in the art, the technical resources can be distributed throughout a network. For example, presentation can be achieved using a web application executing on a web server, sharing data with remote data storage facilities, and protected by security devices running on the network edge. For global retailers, the network and facilities can be massive. For smaller retailers, the supporting computing resources can be more modest, potentially comprising—albeit extreme—a single personal computer with internet access.

The website is also provided with intuitive navigation tools, comprehensive merchandise descriptions and images, flexible product searching capabilities, electronic forms enabling various payment methodologies, information related to purchasing and shipping policies, contact information, and promotional and marketing collateral for the site and site merchandise.

The website can be operated, managed, or otherwise directed by non-traditional retailers (i.e., entities that primarily provide non-retail related services, but nonetheless sell merchandise to end users). For example, to complement existing sales channels, a manufacturer (e.g., an OEM) may initiate direct-to-customer sales through a virtual storefront added to a website that had otherwise been previously used only to provide news and public information. Similarly, a non-manufacturing organization (e.g., sports organization or entertainment venue) may incorporate a virtual storefront to their web site to sell products that are either related to that organization or of interest to members of that organization (e.g., branded products, tickets, and souvenirs).

As shown in FIG. 1, selling criteria 22 is entered by a retailer using a retailer computing device 20 logged into network 10, for example, through an application server 18. As used herein, the term “selling criteria” shall be construed to include any terms, limitations, or requirements set by a retailer for selling merchandise.

Although the principal selling criteria is “price”, price is not necessarily the only selling criteria. Others include, but are not limited to, “quantity”, “location”, and “date”. In respect of “quantity”, a retailer can place limits on the number of merchandise offered for sale for several reasons. For example, a quantity limitation may simply reflect inventory, which is finite. Even if not limited by supply, quantity may be limited (minimum or maximum orders) as result of a contractual arrangement with a supplier or to accommodate a marketing model for a particular item of merchandise.

In respect of “location”, a retailer may need to impose limits on where particular items are sold, such as particular stores, regions, and states. Rationales for location-based limitation include, for example, supply and distribution chain factors, legal and regulatory restrictions, contractual arrangements, and marketing strategies.

In respect of “date”, a date limitation can be imposed when merchandise is not available until a particular date. Such instance typically occurs for merchandise that is pre-marketed or pre-advertised prior to availability, such as common in media or event related merchandise. In contrast to pre-ordering functions provided currently on several published online retail websites, the “date” criteria—when used in the present invention—is used in combination with “price” criteria.

Despite possible inclusion of other selling criteria, in all embodiments of the present invention, “price” is always a selling criterion. In practice, exceptions are expected, such as those resulting from entry errors and website posting and maintenance schedules. Regardless, for essentially all items of merchandise offered for sale on the ecommerce website, an “offered price point” is established.

As used herein, “offered price point” shall be defined as the price at which merchandise is offered for sale and which, when accepted buy a customer, leads to consummation of that sale without further negotiation. In the context of the present invention, once computational comparison finds an appropriate match on price relative to the ruling engine criteria, the invention proceeds towards an automated electronic alert and/or purchasing procedures.

A computer network used by the retailer to host the ecommerce website can comprise a plurality of interconnected computers and terminals, servers, data storage facilities, hubs, routers, switches, network security devices, network management devices, wireless nodes and access points, load balancers, and related software. Within this network, data relating to customer accounts and merchandise is stored within the network's data storage facilities, with web serving facilities publishing the ecommerce website, which draws upon, interacts with, and provides access to such data.

The data storage facilities can comprise one or more data storage devices capable of recording and retrieving digital information from a medium (e.g., magnetic, optical, semiconductor, etc.). For small to medium-scale retailers, the data storage facilities can utilize storage with comparatively modest capacity, such as provided by a single internal or external hard drive or flash drive. For large global retailers, the data storage facilities will require greater capacity and bandwidth, and thus, may employ several networked and attached electronic data storage components, which may be deployed at an enterprise-scale and may include, for example, arrays of data servers and file servers; SAN and NAS storage facilities; RAID storage systems, data backup, archiving, and redundancy facilities; and data management and load balancing agents.

Customer account and merchandise related data can be stored and retrieved from the data storage facilities utilizing well known database technologies. Examples of data management tools for small to medium-sized retailers include consumer-grade software packages as will be understood by those of skill in the art. For large global retailers, internal and external database design, development, and management can implement any of the various DBMS and models currently available based on SQL, NoSQL, MySQL, XML, OQL, and like database programming languages.

The input of customer-definable buying criteria 32 is accomplished using a customer interface, such as that provided on an ecommerce website. As shown schematically in FIG. 1, the ecommerce website can be published from a retailer's computing network 10 through the use of a web server 14. Access into website by a customer can be accomplished with a personal computer or like retailer computing device 20 equipped with a suitable internet browser.

The exemplary customer interface includes all element of the ecommerce website used by a customer to interact with the website, for the purpose of gathering and submitting information and data from and to the retailer's computing network in relation to the buying and selling of merchandise. The customer interface can include, for example, pointers, cursors, radio buttons, icons, hyperlinks, menus, tables, lists, check boxes, input fields, line interfaces, images, scroll bars, bookmarks, sliders, toggle switches, popup notes, dropdown calendars, wheels, and dials. Customer input can be accomplished through a keyboard (e.g., a physical keyboard on a laptop computer or a dropdown keyboard on a smartphone application), a pointing device (e.g., a mouse), touch (e.g., on a touch-sensitive capacitive screen), stylus (e.g., on a pressure-sensitive resistive screen), and/or though other input sensing devices (e.g., magnetic stripe readers, optical scanners, and voice scanners).

Despite variability, the customer interface is in all instances of invention provided with means for performing a series of three basic steps. First, means are included to enable a customer to obtain information about an item of merchandise. Second, once the information is obtained, confirming that the item does exist for possible sale, means associated with the customer interface enable the customer to “tag” or otherwise “set aside” that item; i.e., an item that the customer wishes the retailer to act upon when certain criteria are met. Third, once tagged, means associated with the customer interface enable a customer to define certain buying criteria for the selected item. In the embodiment described below, the buying criteria are established by a ruling engine. In sum, the customer interface has embodied therein or associated therewith (1) means for browsing items, (2) means for selecting items, and (3) means for setting criteria for selected items. Of course, the interface may include additional features related to generating alerts, purchasing selected items, cancelling items from a shopping list, etc.

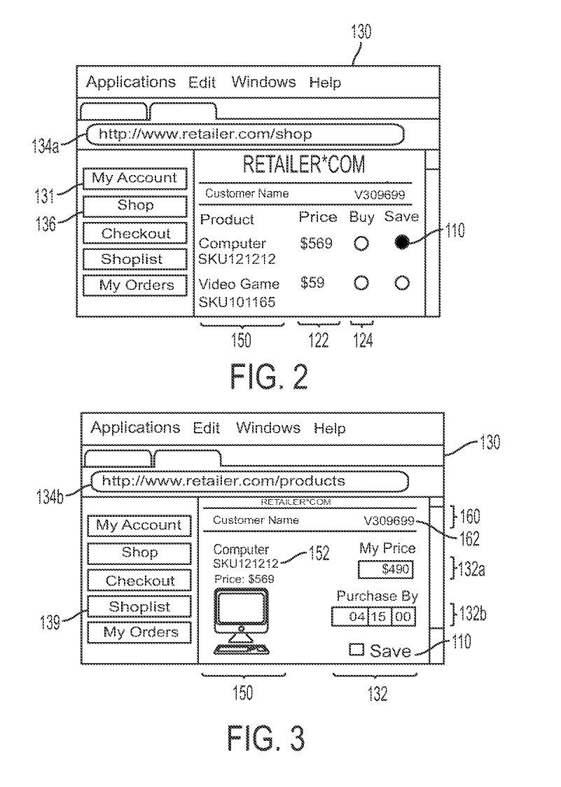

FIG. 2 illustrates a representative customer interface for a hypothetical ecommerce website according to an embodiment of the present invention. The hypothetical website 130 entitled “Retailer*Com” in FIG. 2 may be, for example, accessible to customers through the hypothetical URL address<http:/www.retailer.com>134a as will be understood by those of skill in the art. As shown, radio button 110 labeled “Save” effects directly or indirectly the “tagging” of a selected item (e.g., “Computer SKU 121212), resulting in the placement thereof onto the customer's shopping list.

The customer interface of the ecommerce website or hypothetical website 130 includes navigation buttons, which enable a customer to access and browse the website's content. By way of example, the website may include access to a customer's account information via a “My Account” button 131 in order for the customer to access certain account details such as name, address, shipping information, billing information, etc. Among the navigation buttons is a button 136 labeled “Shop”, which links to a dashboard for buying merchandise in a manner that is known to those of skill in the art because the button itself may encompass any type of on-line shopping website. As shown, the shopping dashboard is coded to sell (cf., radio buttons 124 labeled “Buy”) a selection of merchandise 150 (including “Computer SKU 121212”) at retailer-defined offered price points 122. The specific arrangement and layout of the retail shopping venue may take any form suitable to attract and serve customers in the marketplace.

FIG. 3 illustrates a hypothetical webpage or dashboard showing products selected by a consumer in accordance with an embodiment of the present invention. In addition to means for buying merchandise, the customer interface for the ecommerce website 130 also has means for saving particular items onto a shopping list associated with a customer's individual account 162. As shown, radio button 110 labeled “Save” effects directly or indirectly the “tagging” of a selected item (e.g., “Computer SKU 121212), resulting in the placement thereof onto the customer's “shopping list” as shown in FIG. 3. Clicking radio button 110, if desired, can be engineered to automatically navigate into the item's specific listing within the customer's shopping list shown in FIG. 3. Alternatively, navigation into the shopping list dashboard 134b can be achieved by clicking navigation button 139 labeled “ShopList”.

Within the shopping list dashboard 134b, the tagged item 152 (i.e., the “Computer”) is displayed together with a product identification number 152 (i.e., SKU 121212) and an offered price point (i.e., $569). The customer interface for the shopping list dashboard 134b, as shown, includes customer input means 132 comprising means for entering a personal price point (i.e., field 132a labeled “My Price” and having an input value of $490). The window may be modified to include: means for selecting one form for alerts (i.e., drop down menu labeled “Alert” and having a selected forms for an alert, e.g. “Text (SMS)”; and/or means for authorizing electronic payment. Other alternative selectable values (not illustrated in FIG. 3) for “Alert” menu can include, for example, “Email”, and/or a deadline to purchase a selected item shown as a “purchase by” criteria 132b.

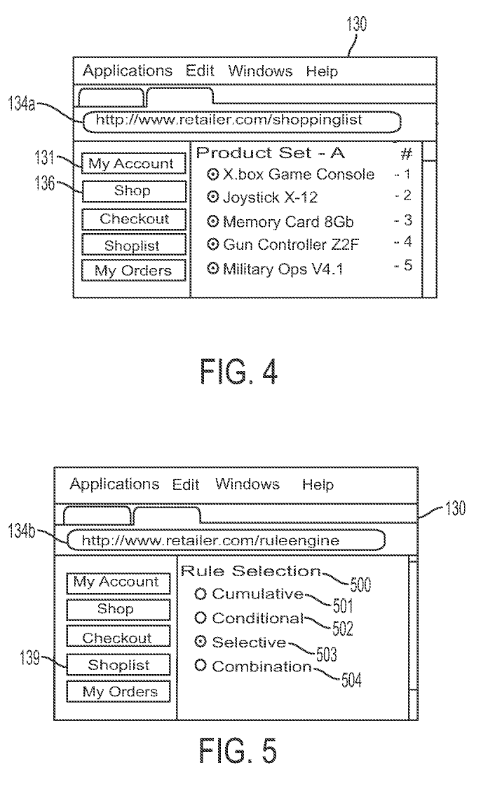

FIG. 4 illustrates an example of a product set selected by a consumer to define a shopping list of items according to an embodiment of the present invention. According to the invention, a consumer may make a selection of items from an online shopping website as shown in FIGS. 2 and 3. Then, the selected products may be viewed in a shopping list window such as illustrated in FIG. 3, in which the consumer may group certain products, where, as in FIG. 4, the product set A has been grouped by product type as these products relate to gaming devices and accessories.

FIG. 5 illustrates an example of a ruling engine page providing pricing options and rules for use by the consumer according to the present invention. As shown by FIG. 5, the customer interface permits the user to select one or more rules selected to govern the sales conditions preferred by the user. As discussed above, the present invention proposes a system wherein purchase options in the form of a rule selection option 500 may include a cumulative pricing rule 501, a conditional pricing rule 502, a selective pricing rule 503, and a combination pricing rule 504. In the example of FIG. 5, the user has selected the selective pricing rule 503 to govern the potential purchase of items listed for Product Set A shown in FIG. 4.

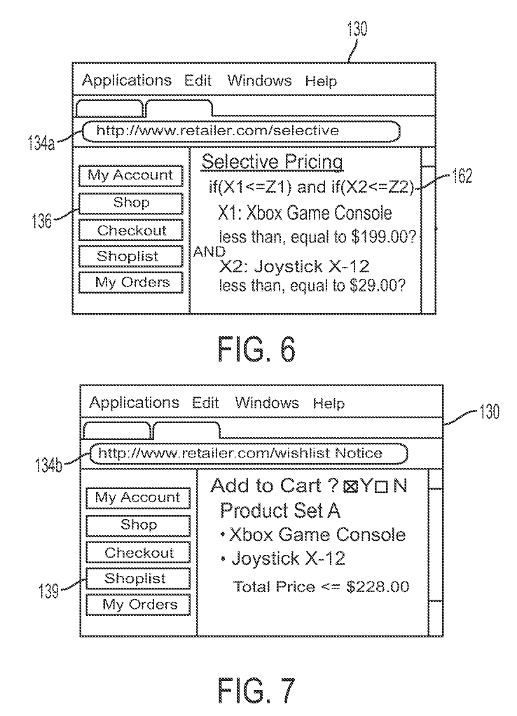

FIG. 6 illustrates an exemplary customer interface showing the selective pricing rule being applied to product set A of FIG. 4 in accordance with an embodiment of the present invention. Here, the selective pricing rule chosen by the user requires that first selected product X1 (i.e., Xbox Game Console) must be priced less than Z1 (i.e., $199.00), and the second selected product X2 (i.e., Joystick X-12) must be less than $29.00. These terms are defined by the user in the customer interface. While price in dollars is listed in the example of FIG. 6, it is noted that other value may be placed on the transaction such as rewards points, other products for trade, coupons, and any other item of value that a retailer or seller may be willing to accept for value in a commercial transaction.

The system according to the present invention next monitors and evaluates pricing conditions presented by retailers in real time and others placing goods on the market for purchase and, when the pricing terms defined by the user's selection in the ruling engine match, the customer is notified by an appropriate alert or other means. FIG. 7 illustrates a notice interface presenting products matching the customer's conditions set forth in the ruling engine according to an embodiment of the present invention. A notice interface as shown in FIG. 7 notifies the customer of products matching the conditions set forth by the ruling engine as illustrated in FIG. 6. The interface may allow the customer to add the selected products to the customer cart for purchase using any technique known to those of ordinary skill in the art. According to the invention, a customer may select all of the items or only a subset of the products to add to the cart.

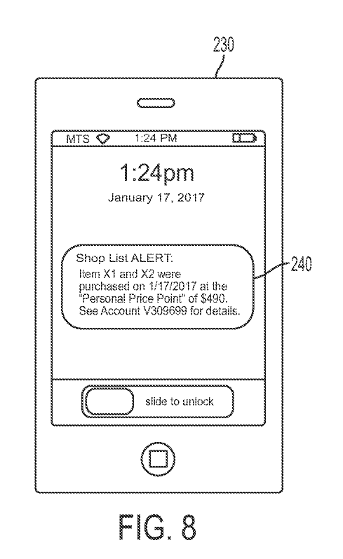

FIG. 8 provides an illustration of a representative “alert” triggered by a personal price point, such as that illustrated in FIG. 2, according an embodiment of the present invention. In particular, once a personal price point is set for an item of merchandise, computational comparisons are conducted periodically to determine if a suitable match exists between the retailer's selling and the customer's buying criteria. For example, if a retailer decides to re-price the selected item of merchandise 150 (i.e., “Computer SKU 121212”) in shopping list dashboard 134b previously tagged by customer ID 160 (i.e., customer I.D. No. “V309699”) from an offered price point of $569 to an offered price point of $490, in accordance with the present invention, an alert or customer alert 240 is transmitted as a text message to a customer smart phone 230.

As shown, the customer alert 240 provides information identifying the item of merchandise (i.e., “Computer SKU 121212”), the account (i.e., customer I.D. no. “V309699”), the date (i.e., “Jan. 17, 2017”), the buying criteria (i.e., “‘Personal Price Point’ of $490”), and the action taken (i.e., “purchased”).

Although the present invention does not require automated purchase, for purposes of illustration, alert 240 in FIG. 8 signifies consummation of such purchase for consistency with the authorization exemplified in FIGS. 2-7. When automated purchase is not requested, the alert may simply indicate, for example, that the “Personal Price Point” was “met”.

In respect of “tagging” merchandise, any methodology or instrumentality enabling a customer to select a particular item of merchandise from the retailer's online inventory of salable merchandise is within the scope of the invention.

“Tagging” can be accomplished by providing tags, tokens, labels, flags, indicators, fields and/or the like within the data record for the item of merchandise, for example, in a flat file database stored within the data storage facility of the retailer's computer network. Alternatively, “tagging” can be supported by encoding appropriate parent-child relationships among the ecommerce-related data tables of a relational database. Such relational database structures are preferred for complex ecommerce systems, offering comparatively better flexibility, modularity, and efficiency in the creation, presentation, reporting, searching, manipulation, and sorting of ecommerce related data. Other methods of tagging, marking, flagging, or otherwise differentiating specific items from a collection thereof are available to those skilled in the art in light of the present disclosure.

The term “buying criteria”—as construed herein—includes any terms set by a customer for either (a) buying merchandise or (b) generating interest towards potentially buying merchandise. The setting of the “buying criteria” does not require a customer to consummate a purchase, or otherwise create any actual commitment to consider, reconsider, or proceed in any manner with respect to a flagged item of merchandise. The act of differentiating merchandise per se is sufficient indicia of that customer's interest in the item offered for sale.

As with the “retailer-definable selling criteria”, the principal “customer-definable buying criteria” is “price”. Other buying criteria nonetheless includes, but is not limited to “quantity”, “location”, and “shipping and delivery preferences” as well as any other preferences significant to the customer.

In respect of “quantity”, the means for setting buying criteria can include the triggering of notices or automated purchases, for example, when a previously unavailable item (cf., retailer quantity=0) becomes available (cf., retailer quantity>0), or when a previously “limited quantity” item becomes “unlimited” or adjusted to a new lower limit, provided matching price criteria is also present.

In respect of “location”, a customer may wish to purchase items only at a specific store, or within a specific region, or within a specifiable radius from a specifiable location. This criterion is particularly useful for traditional retail store shopping. The ability to trigger alert notices as a function also of location-related buying criteria can facilitate travel planning of customer shopping activities.

In respect of “shipping and delivery preference”, the mean for setting buying criteria can include the triggering of notices or automated purchases as a function also of, for example, whether shipping and/or delivery is free, expedited, discounted, guaranteed, etc. Such buying criteria would be particularly useful for on-line purchases.

Despite other buying criteria, in all embodiments of the present invention, “price” is always included within the “customer-defined buying criteria”.

Given the importance of a customer's personal price points, restriction and/or filters are imposed on the value inputted by a customer, for example, by utilizing data handling and validation protocols and algorithms well known in the field of web design. Typical validations would include checks for appropriate numerical format and checks to determine whether an inputted value falls within acceptable range. For embodiments where computational comparisons would only potentially trigger the transmission of an alert, attention and resources employed to validate inputs can be relaxed to the extent that use and/or acceptance of erroneous data would engender comparatively less risk. Tight validation protocols, however, are desirable when automated purchasing is involved, for example, to prevent triggering a purchase based on computational comparisons tainted or corrupted by faulty data input, or to prevent a customer from unintentionally mistyping a higher price potentially triggering an unwanted automated purchase.

The personal price points, as well as other customer-definable buying criteria, can have associated therewith a retailer or customer definable expiration date, beyond which the criteria will no longer be considered. A customer may utilize such feature, for example, to prevent automated purchasing of an item beyond a relevant date (cf., a holiday, birthday, or anniversary). A retailer may also find such feature useful, for example, to manage network resources, bandwidth, and data integrity.

As mentioned, with buying and selling criteria stored within a retailer's network, real-time, computational comparisons are executed continuously or periodically to determine whether further action on a tagged item of merchandise is merited.

As shown in FIG. 1, computational comparison is affected by a data processing agent 16 installed and operating within the retailer's computing network 10. Data processing agent 16 is arranged in communication with the network's data storage facility 12, such that the data storage facility 12 has access to both customer account data 60 (thereby providing access also to items of merchandise 64 tagged with customer 62's buying criteria 32) and the retailer's merchandise data 50 (thereby providing access also to the retailer's selling criteria 22 for particular items of merchandise 52). Data storage facility 12 retrieves relevant data from the customer account 60 and merchandise data 50 and performs the computational comparisons that, if merited, ultimately lead to an automated alert 40 and/or the purchase of the item of merchandise 52.

As is known in the art, the data processing agent 16 can comprise well-known hardware and software components, consolidated in a single central location or device, or distributed over several devices and/or locations, real or virtual, within the administrative control of the retailer or the retailer's agent. Mathematical functionality of a data processing agent 16 can be engineered for execution, partially or completely, on a client-side internet browser or web application. Due to resource and control limitations on client-side devices, such embodiments are at present felt more appropriate for modest deployments. For deployment at an enterprise-scale, the data processing agent 16 is may be executed completely or substantially within the administrative jurisdiction of the retailer's computing network.

The frequency of computation is subject to variation but should be performed in real time taking into account the multiple products included in the product set. Retailers that deal in small and narrow inventories and/or merchandise with stable price points may not need to compute as frequently as a retailer dealing with diverse and fluid inventories subject to persistent price and demand fluctuations. In one mode of practice, calculations can be manually commenced (cf., clicking a “submit” button) after a retailer adjusts prices or quantities. Although labor intensive, this option has the advantage of potentially providing better retailer control. Another possibility would be to commence calculations based on a particular schedule (e.g., weekly, daily, hourly, etc.). In this regard, more frequent calculation could lead to faster product turnover.

The types of computational calculation depend on the data types involved in the buying and selling criteria. When only price is involved, the calculation may be a mathematical calculation, such as subtracting the retailer's offered price point value from the customer's acceptable price point value, such that the absence of a difference (or a negative difference) triggers an automated retail transaction on the tagged item of merchandise.

Given the possibility that other criteria are involved, as well as different forms of data input (i.e., integers, floating point real values, alphanumeric strings, Boolean, etc.), the term “computational comparison” should not be construed as limited to any particular calculation, algorithm, or mathematical process, but rather should viewed with an eye towards functionality. Regardless of the calculation, algorithm, or mathematical process employed, “computational comparison” decides whether action is taken on customer-tagged merchandise. In other words, the automated retailer transaction is a function of, and relies upon, directly or indirectly, computer-executed processing of the retailer and customer selling and buying criteria.

As shown in FIG. 1, an electronic notification or automated alert 40 is transmitted from or otherwise effected by the retailer's computing network 10 to the customer's computing device 30 as a function of the computational comparisons performed by the data processing agent 16.

The electronic alert 40 includes any information capable of indicating, signifying, or conveying to the customer a result of a computational comparison of the customer's buying criteria and the retailer's selling criteria. The electronic alert 40 can be provided in the form of general or specific text-based information, image-based information (e.g., a distinctive pop-up graphical icon or image), or audio-based information (e.g., an automated voicemail message, a distinctive ring tone, etc.)

The preferred electronic alert 40 is an email or text message, for example, sent from an email facility (not illustrated) provided on the retailer's computer network 10 to a customer's email account hosted by a third party provider (e.g., an internet service provider, social networking site, or free email provider). Addressing information for the email transmission can be provided by the customer within profile data in the customer account 60.

Similarly preferred, the electronic alert can be a text message, for example, sent from an SMS (“Short Message Service”) facility (not illustrated) hosted on the retailer's computer network 10 to a customer's cell phone, hosted by a third-party telecommunication carrier. By using known email-to-sms gateway technologies, an alert in the form of an email message can be sent through SMS communication protocols. The cell phone number for the text message can also be provided by the customer within the customer's profile data.

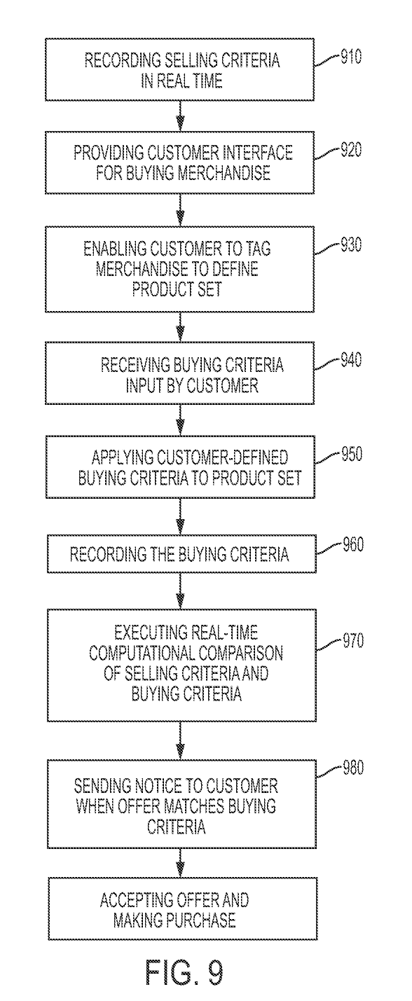

FIG. 9 is a flowchart showing the steps of applying price rules to a group of products identified by a customer according to an embodiment of the present invention. With reference to FIG. 9, the steps employed to accomplish the real-time automated price rule notification methodology is shown, to wit, at step 910 the system of computer network 10 records retailer defined selling criteria in real time. Next, at step 920 the customer is provided with an interface for buying product and/or services; i.e., merchandise and at step 930 the customer is provided with the ability to tag a group of merchandise to define a product group as that term is used herein. Next, the customer inputs the user-defined buying criteria at step 940 as prescribed by the ruling engine and the price rules set forth therein. The system 10 then at step 950 applies the buying criteria to the product set defined by the customer or consumer thus creating a link between the grouping of products and the buying criteria for these products, services or merchandise. Next, the buying criteria are recorded at step 960 for use and application by the system 10. Next, a real-time computational comparison is conducted and executed at step 970 to monitor and evaluate whether products currently on the market matching the product set created by the customer also match the buying criteria also established by the customer. The computation comparison is significant because the comparison is a real-time analysis of multiple products and multiple price points across wide range of data sources. Such real-time computation comparison is not known in the art and cannot be accomplished by human intellect. Once the computational comparison determines that a match exists between selling criteria established at step 910 and the buying criteria established at steps 940-960, the system 10 sends a notification at step 980 to the customer of a matching offer for the product set in accordance with the buying criteria. Lastly, at step 990 the customer may accept the offer and purchase the merchandise identified at step 980 via the dashboard illustrated in FIG. 7 or other suitable purchasing means.

In one mode of practice, the automated electronic purchase feature—as is the case also with the automated electronic alert feature—is presented within a broader online shopping utility of an ecommerce web site as an independent standalone feature, having a dedicated dashboard and user interface.

Conciseness, clarity, and organization can be advanced however by integrating, combining, or associating the automated purchase feature within an ecommerce listing facility, such as a “shopping list” or “watch list”. In many instances, such wish list facilities may already be provided on a pre-existing ecommerce website, and integration of the present invention, may involve only comparatively modest modifications thereto.

Integration can produce relatively seamless results and can avoid or otherwise reduce the need for potentially redundant website utilities, functions, and/or dashboards. By organizing the inventive system within a consolidated shopping list tool, customer attention is focused and engaged. Unnecessary distractions and diversions are avoided.

The shopping list facility—whether pre-existing or not—should be configured to enable a customer using a suitable customer interface to record a list of merchandise or product set in association with the customer registered personal account. As is common practice, a shopping list essentially comprise items that customers do not wish to purchase until future conditions are met, and wish to consider for possible future purchase, or more fundamentally, for purposes only of price monitoring and tracking.

For embodiments enabling automated purchases, the input means for the shopping list facility is engineered to enable customers at a minimum: (1) to tag merchandise with customer buying criteria; and (2) to provide customer purchase pre-authorization. Means are also included for recording in association with the customer's registered personal account other relevant customer profile and purchasing information (e.g., customer name, identification number, shipping and billing addresses, credit card and bank information, etc.).

In accordance with the invention, electronic purchasing of tagged merchandise, using information and resources shared with and/or otherwise accessible to the shopping list facility, is a function of both the customer purchase authorization and computational comparison of stored buying and selling criteria. When triggered, the automated electronic purchase is executed utilizing the customer purchase information in the customer account.

As an alternative to an ecommerce website, the invention can also be embodied as a web or internet application installable and executable, for example, on a smartphone, internet-enabled tablet, or other mobile personal digital device. Many of the same back-end computing resources used for an ecommerce website (e.g., data storage facilities, web servers, databases, data processing agents, etc.) can be used for or shared with the web application, with front-end resources (e.g., customer interfaces, dashboards, authentication, etc.) engineered specifically for the mobile personal digital device.

In an embodiment, an e-commerce internet application is provided comprising: a customer interface enabling a customer to both buy merchandise and tag merchandise with customer-definable buying criteria that includes at least an acceptable price point matching the pricing rules of the pricing engine; means for recording the customer-definable buying criteria at the data storage facility; means for executing a real time computational comparison of the retailer-definable selling criteria and the customer-definable buying criteria; and means for transmitting an alert to the customer as a function of said computational comparison.

It is not required that recording, computing, and transmitting means of the “internet app” be installed and/or executable completely on the mobile personal digital device. For example, the “means for executing a computational comparison” may comprise only a few lines of code in the application that relate to the submission of customer buying criteria, which when executed, ultimately leads to the performance of said computational comparison within the back-end resources available to the internet application.

Similarly, in respect of the “means for transmitting an alert”, the internet application may comprise only a few lines of code relating to and/or effecting the selection and submission of certain alert parameters to the retailer's back-end resources that ultimately are directly responsible for transmitting the alert.

As stated hereinabove, the alert can be sent to any customer prescribed email address or cell phone number. In an embodiment of the internet application, the alert is transmitted back to the device on which the application is hosted, using digital addressing information culled from the device by the internet application during installation and/or as a result of customer use.

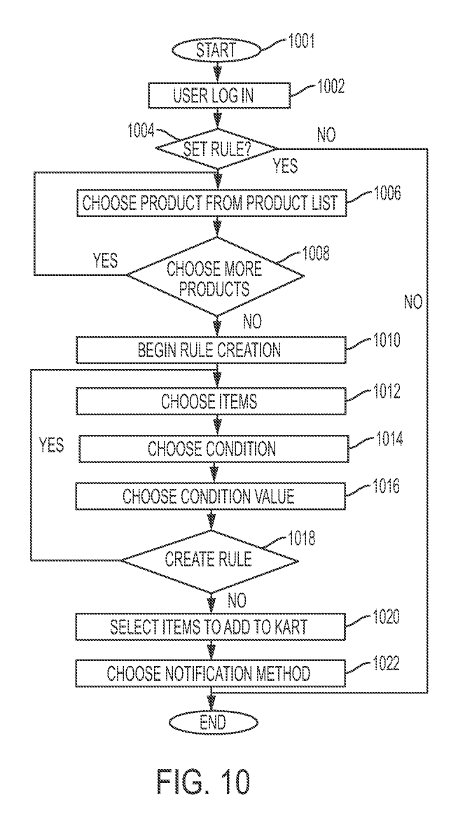

FIG. 10 illustrates a flowchart showing an example of consumer data flow according to an embodiment of the present invention. More specifically, FIG. 10 illustrates a detailed flow chart from the time a user logs-in until the user completes the rule setting process described above. Once a user navigates to a rule setting page, after starting at step 1001 and logging in at step 1002, the user will set appropriate rules for a purchase at step 1004. At step 1006, the user will need to select a list of product over which rule will be applied. The customer can select any number of products from the available item details at step 1008. Once the process is complete, the user can begin with creating the rules at steps 1010-1018. According to an embodiment of the invention, the user at step 1012 will choose an item and apply an appropriate rule such as cumulative pricing, conditional pricing, selective pricing and combined pricing rule. Thus, the user will choose a condition at step 1014, then choose a condition value such as price at step 1016. Lastly, the user will apply the rule value step 1018. User can loop through to create multiple rules.

Once steps 1010-1018 are done, the user will choose a list of products to add to a cart at step 1020 if the condition returns true and then the user will select a notification method at step 1022.

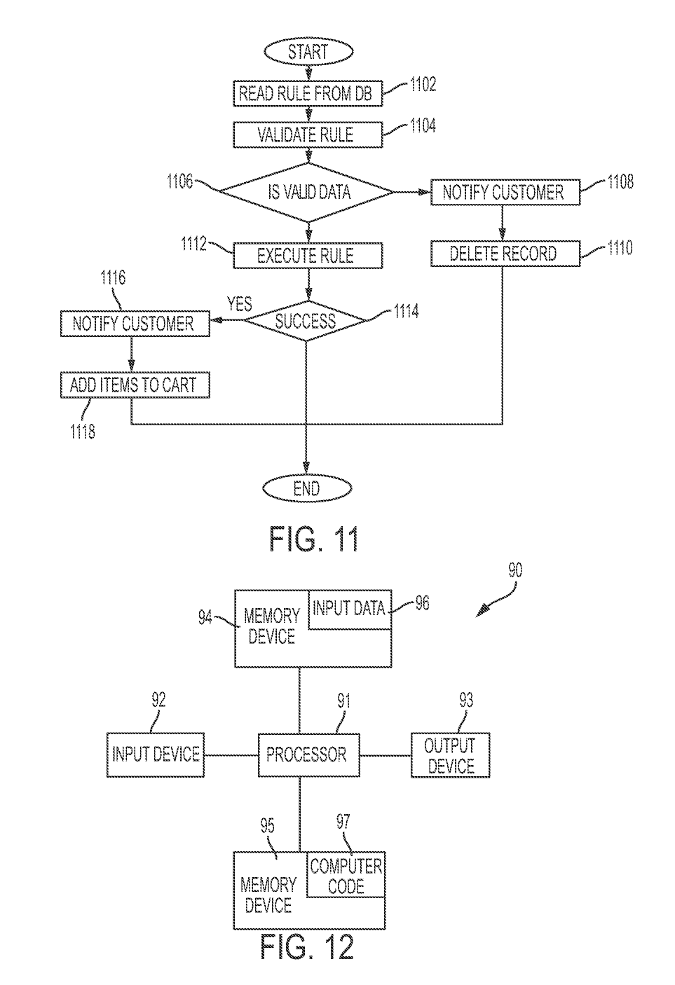

FIG. 11 illustrates a flowchart for one example of system data flow according to an embodiment of the present invention. The process reads the database at step 1102 for a rule string at periodic interval configured by the administrator and checks if the rule remains valid and/or if the rule has expired at step 1104. A rule may expire for a number of reasons, for example, a customer may set a time limit on specific rule. By way of example, a customer may wish to purchase a specific set of products for a birthday or a holiday, and the customer may set a time limit for the rule to expire because the customer want to receive the products in advance of the birthday or holiday. Of course, a customer may have many reasons for setting an expiration date on a rule. At step 1106, the system 10 determines if the rule is valid based on step 1104. If expired, the system 10 will notify the customer at step 1108, deletes the record at step 1110 and exits. If valid, the system 10 will execute the rule at step 1112. Successful completion of a rule is determined at step 1114. If the rule returns true, the system 10 will likewise notify the customer at step 1116 and add the item(s) to the cart at step 1118 and exits. If not, the system 10 will naturally exit, and the rule will be checked during the next iteration process. These steps summarize one example of the system data flow but variations are possible, for example, the item may be added to the cart at step 1118 prior to notifying the customer at step 116, etc.

FIG. 12 illustrates a computer system 90 used for implementing the methods of the present invention. The computer system 90 includes a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97 which is a computer program that includes computer-executable instructions. The computer code 97 includes software or program instructions that may implement an algorithm for implementing methods of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 9) may be used as a computer usable storage medium (or program storage device) having a computer readable program embodied therein and/or having other data stored therein, wherein the computer readable program includes the computer code 97. Generally, a computer program product (or, alternatively, an article of manufacture) of the computer system 90 may include the computer usable storage medium (or said program storage device).

The processor 91 may represent one or more processors. The memory device 94 and/or the memory device 95 may represent one or more computer readable hardware storage devices and/or one or more memories.

Thus the present invention discloses a process for supporting, deploying and/or integrating computer infrastructure, integrating, hosting, maintaining, and deploying computer-readable code into the computer system 90, wherein the code in combination with the computer system 90 is capable of implementing the methods of the present invention.

While FIG. 12 shows the computer system 90 as a particular configuration of hardware and software, any configuration of hardware and software, as would be known to a person of ordinary skill in the art, may be utilized for the purposes stated supra in conjunction with the particular computer system 90 of FIG. 12. For example, the memory devices 94 and 95 may be portions of a single memory device rather than separate memory devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A method of real-time automated price rule notification for disparate products selected from a group of products in at least one retailer-operated e-commerce website, the at least one e-commerce website coded to sell merchandise according to retailer-definable selling criteria, the selling criteria comprising at least an offered price point, the method comprising the steps of:
recording, by a computer, retailer-definable selling criteria for merchandise stored at a data storage facility in real time from a plurality of disparate data sources;
providing, by said computer, a customer interface on a website enabling a customer to buy said merchandise at an offered price point;
receiving, by said customer interface on the computer, from the customer a selection to tag merchandise which defines a customer-defined product set of merchandise of interest to the customer selected from said plurality of disparate data sources;
receiving, by the computer, customer-defined buying criteria, the buying criteria comprising rule-governed pricing input by the customer for disparate products included in said customer-defined product set;
recording, by the computer, the customer-defined buying criteria at the data storage facility;
executing, by the computer, real time, periodically computational comparisons of the retailer-definable selling criteria and the customer-defined buying criteria; and
sending, by the computer in real time, a notice to the customer in response to said retailer-definable selling criteria matching said customer-defined buying criteria.

2. The method of claim 1, further comprising:
providing cumulative pricing criteria as a part of said buying criteria, whereby a single price is set as a criterion for said group of products, and said cumulative pricing criteria matching said retailer-definable selling criteria matches said single price for said group of products.

3. The method of claim 1, further comprising:
providing a conditional pricing criteria as a part of said buying criteria, and a predetermined price is set as a criteria for each product of at least two products selected from said group of products, and said conditional pricing criteria is met when said predetermined price for at least one product of said at least two products matches said retailer-definable selling criteria.

4. The method of claim 1, further comprising:
providing a selective pricing criteria as a part of said buying criteria, and a predetermined price is set as a criteria for each of at least two products selected from said group of products, and said selective pricing criteria is met when said predetermined price for both products of said at least two products matches said retailer-definable selling criteria.

5. The method of claim 4, further comprising:
providing cumulative pricing criteria as a part of said buying criteria, whereby a single price is set as a criterion for said group of products, and said cumulative pricing criteria matching said retailer-definable selling criteria matches said single price for said group of products;
providing a conditional pricing criteria as a part of said buying criteria, and a predetermined price is set as a criteria for each product of at least two products selected from said group of products, and said conditional pricing criteria is met when said predetermined price for at least one product of said at least two products matches said retailer-definable selling criteria;
providing a selective pricing criteria as a part of said buying criteria, and a predetermined price is set as a criteria for each of at least two products selected from said group of products, and said selective pricing criteria is met when said predetermined price for both products of said at least two products matches said retailer-definable selling criteria; and
providing combined pricing criteria as a part of said buying criteria, whereby said customer selects at least two criteria of said cumulative pricing criteria, conditional pricing criteria, and said selective pricing criteria, and said combined pricing criteria is met when said retailer-definable selling criteria matches said two criteria.

6. The method of claim 1, wherein the e-commerce website comprises a shopping list facility, the shopping list facility enabling said customer using the customer interface to record in association with a customer account a list of said merchandise, wherein the customer account is hosted on the data storage facility, wherein the customer-definable buying criteria is associated with the customer account, and wherein the tagged merchandise is recorded in the list of said merchandise.

7. The method of claim 1, further comprising:
transmitting an alert as said notice to the customer as a result of a determination by the computational comparison that the offered price point is equal to or less than the acceptable price point.

8. The method of claim 1, wherein the retailer-definable selling criteria includes selling location, and wherein the customer-definable buying criteria includes buying location.

9. The method of claim 1, wherein the retailer-definable selling criteria includes merchandise availability information, and wherein the customer-definable selling criteria includes merchandise quantity information.

10. The method of claim 1, further comprising:
enabling the customer to make a customer purchase authorization of a purchase by the customer; and further comprising the step of: executing an electronic purchase of said product set as a function of both (a) the customer purchase authorization and (b) the real-time computational comparison of the retailer-definable selling criteria and the customer-defined buying criteria, the executing said electronic purchase comprising utilizing the customer purchase information in the customer account.

11. A computer program product comprising:
a computer-readable storage device; and
a computer-readable program code stored in the computer-readable storage device, the computer readable program code containing instructions executable by a processor of a computer system to implement a method of real-time automated price rule notification for disparate products selected from a group of products in at least one retailer-operated e-commerce website coded to sell merchandise according to retailer-definable selling criteria, the method comprising:
recording retailer-definable selling criteria for merchandise at a data storage facility in real time from a plurality of disparate data sources;
providing a customer interface on a website enabling a customer to buy said merchandise at an offered price point;
receiving from the customer a selection to tag merchandise which defines a customer-defined product set of merchandise of interest to the customer;
receiving customer-defined buying criteria, the buying criteria comprising rule-governed pricing input by the customer for disparate products included in said customer-defined product set;
recording the customer-defined buying criteria at the data storage facility;
executing real time, periodically computational comparisons of the retailer-definable selling criteria and the customer-defined buying criteria; and
sending, in real time, a notice to the customer in response to said retailer-definable selling criteria matching said customer-defined buying criteria.

12. The computer program product of claim 11, further comprising:
providing cumulative pricing criteria as a part of said buying criteria, whereby a single price is set as a criterion for said group of products, and said cumulative pricing criteria matching said retailer-definable selling criteria matches said single price for said group of products.

13. The computer program product of claim 11, further comprising:
providing a conditional pricing criteria as a part of said buying criteria, and a predetermined price is set as a criteria for each product of at least two products selected from said group of products, and said conditional pricing criteria is met when said predetermined price for at least one product of said at least two products matches said retailer-definable selling criteria.

14. The computer program product of claim 11, further comprising:
providing a selective pricing criteria as a part of said buying criteria, and a predetermined price is set as a criteria for each of at least two products selected from said group of products, and said selective pricing criteria is met when said predetermined price for both products of said at least two products matches said retailer-definable selling criteria.

15. The computer program product of claim 11, further comprising:
providing cumulative pricing criteria as a part of said buying criteria, whereby a single price is set as a criterion for said group of products, and said cumulative pricing criteria matching said retailer-definable selling criteria matches said single price for said group of products;
providing a conditional pricing criteria as a part of said buying criteria, and a predetermined price is set as a criteria for each product of at least two products selected from said group of products, and said conditional pricing criteria is met when said predetermined price for at least one product of said at least two products matches said retailer-definable selling criteria;
providing a selective pricing criteria as a part of said buying criteria, and a predetermined price is set as a criteria for each of at least two products selected from said group of products, and said selective pricing criteria is met when said predetermined price for both products of said at least two products matches said retailer-definable selling criteria; and
providing combined pricing criteria as a part of said buying criteria, whereby said customer selects at least two criteria of said cumulative pricing criteria, conditional pricing criteria, and said selective pricing criteria, and said combined pricing criteria is met when said retailer-definable selling criteria matches said two criteria.

16. The computer program product of claim 11, wherein: the e-commerce website further comprises a shopping list facility, the shopping list facility enabling said customer using the customer interface to record in association with a customer account a list of said merchandise; the customer account is hosted on the data storage facility; the customer-definable buying criteria is associated with the customer account; and the tagged merchandise is recorded in the list of said merchandise.

17. A computer system, comprising:
a processor;
a memory coupled to said processor; and
a computer readable storage device coupled to the processor, the storage device containing instructions executable by the processor via the memory to implement a method for real-time automated price rule notification of disparate products selected from a group of products in at least one retailer-operated e-commerce website coded to sell merchandise according to retailer-definable selling criteria, the method comprising the steps of:
recording retailer-definable selling criteria for merchandise at a data storage facility in real time from a plurality of disparate data sources;
providing a customer interface on a website enabling a customer to buy said merchandise at an offered price point;
receiving from the customer a selection to tag merchandise which defines a customer-defined product set of merchandise of interest to the customer;
receiving customer-defined buying criteria, the buying criteria comprising rule-governed pricing input by the customer for disparate products included in said customer-defined product set;
recording the customer-defined buying criteria at the data storage facility;
executing real time, periodically computational comparisons of the retailer-definable selling criteria and the customer-defined buying criteria; and
sending, in real time, a notice to the customer in response to said retailer-definable selling criteria matching said customer-defined buying criteria.

18. The computer system of claim 17, further comprising:
providing cumulative pricing criteria as a part of said buying criteria, whereby a single price is set as a criterion for said group of products, and said cumulative pricing criteria is met when said retailer-definable selling criteria matches said single price for said group of products.

19. The computer system of claim 18, further comprising:
providing a conditional pricing criteria as a part of said buying criteria, whereby a predetermined price is set as a criteria for each of at least two products selected from said group of products, and said conditional pricing criteria is met when said predetermined price for at least one of said at least two products matches said retailer-definable selling criteria.

20. The computer system of claim 19, further comprising:
providing a selective pricing criteria as a part of said buying criteria, whereby a predetermined price is set as a criteria for each of at least two products selected from said group of products, and said selective pricing criteria is met when said predetermined price for both products of said at least two products matches said retailer-definable selling criteria.
